(19) United States
(12) Patent Application Publication
(10) Pub. No.: US 2011/0071759 A1
(43) Pub. Date: Mar. 24, 2011

(54) Performance of a Navigation Receiver Operating in a Power-Save Mode with the Aid of Sensors

(75) Inventors: Tarkesh Pande, Dallas, TX (US); Goutam Dutta, Bangalore (IN); Deric Waters, Dallas, TX (US)

(73) Assignee: TEXAS INSTRUMENTS INCORPORATED, Dallas, TX (US)

(21) Appl. No.: 12/887,458

(22) Filed: Sep. 21, 2010

Related U.S. Application Data
(60) Provisional application No. 61/244,695, filed on Sep. 22, 2009.

(51) Int. Cl. G01C 21/00

(52) U.S. Cl. 701/213; 701/200; 701/207

(57) ABSTRACT

A system and method for controlling a navigation receiver is disclosed. A current position is determined using the navigation receiver and then the navigation receiver is placed in a power-save mode. The current position is updated using information from position sensors. The navigation receiver is temporarily placed in an active mode at intervals to determine an intermediate position. The current position is also updated using the intermediate position. The navigation receiver may be a GNSS receiver, a cellular receiver, a WiFi receiver, or another position-fixing device. The position sensors may be accelerometers, gyroscopes, electronic compasses or mapping data. A power-save controller controls the power-save or active mode of the navigation receiver. A sensor conditioning circuit pre-processes the data from the position sensors before providing the data to the power-save controller. During the power-save mode, an RF subsystem and/or a baseband subsystem of the navigation receiver may be turned off.

### CROSS-REFERENCE TO RELATED APPLICATIONS

The present application claims the benefit of the filing date of pending U.S. provisional application No. 61/244,695, titled “Performance of a GNSS Receiver Operating in a Power-Save Mode with the Aid of Sensors,” filed Sep. 22, 2009, the disclosure of which is hereby incorporated by reference herein in its entirety.

### TECHNICAL FIELD

Embodiments of the invention are directed, in general, to navigation systems and, more specifically, methods for a navigation receiver to enter and exit a power-save mode using sensors.

### BACKGROUND

Global Navigation Satellite Systems (GNSS) or satellite navigation systems, such as the United States' Global Positioning System (GPS), the European Union's Galileo system, the Russian GLObal NAvigation Satellite System (GLONASS) system, and China's COMPASS or Beidou systems, may be used to calculate a user's precise position using signals transmitted from satellites. Users may also determine their location by measuring the signal strength of a signal known transmitter, such as a cell phone tower or WiFi (IEEE 802.11) access point, or by triangulation based on the location of known cell phone towers or WiFi access points. Such navigation systems require a receiver to receive satellite signals or radio frequency (RF) signals from cell phone towers or WiFi access points.

Next-generation Global Navigation Satellite System (GNSS) receivers will have internal or external sensors to assist in providing a more accurate navigation solution. An example of a system combining satellite navigation with sensors is disclosed in Dissanayake, et al., “The Aiding of a Low-Cost Strapdown Inertial Measurement Unit Using Vehicle Model Constraints for Land Vehicle Applications,” IEEE Transactions On Robotics And Automation, Vol. 17, No. 5, October 2001, the disclosure of which is hereby incorporated by reference herein in its entirety. This is especially important in scenarios where there is limited GNSS coverage, such as in tunnels or indoors, or in locations where the GNSS signal undergoes significant multi-path, such as in a downtown or urban canyon environment. Some of the sensors envisioned to be used to assist GNSS include accelerometers, e-compasses and gyroscopes.

Known GNSS and other navigation receivers must be on at all times to receive satellite or other RF transmissions so that the user's location can be continuously updated.

### SUMMARY OF THE INVENTION

In embodiments of the invention, sensors may also be used to improve the power consumption and user experience of a navigation receiver. In such instances, the navigation receiver may operate in a power-save mode whereby the navigation receiver goes into a power-save or sleep mode for a percentage of time instead of being in an active state continuously. In such embodiments, the navigation receiver may provide a position report only for those instances when the receiver is on. One such instance is in open-sky scenarios where user acceleration is minimal, such as traveling on a highway. In one embodiment, the navigation receiver operates either in a power-save mode or an active mode. While the navigation receiver is in the power-save mode, the GNSS receiver can be enabled to get position data or disabled to save power. While navigation receiver is in power-save mode, sensors, such as accelerometers, gyroscopes, and e-compass, and/or a mapping application, for example, are actively being used to evaluate when to exit the power-save mode. While the navigation receiver is in active mode, the sensors are actively being used to evaluate when to enter the power-save mode.

In typical GNSS navigation devices, the GNSS receiver resides in a target chip that consists of an RF portion and a baseband processor. The GNSS measurements and/or position fix information is communicated from the target chip to the host. In some cases, the GNSS receiver is divided into a measurement engine and position engine. The measurement engine contains the most computationally demanding functions and is in the target chip. The position engine can run on the host because of its relatively low computational burden as compared to the measurement engine. Sensors reside in an Inertial Measurement Unit (IMU). The raw sensor measurements are passed to a sensor hub, which may reside in the host device or target chip or may be a separate micro-controller that is external to both host and target. The sensor hub buffers the sensor measurements and performs some pre-processing on the sensor data before passing it on to the target and host. Some examples of pre-processing or sensor conditioning include, for example, (a) tilt estimation, (b) tilt compensation on accelerometer, e-compass and gyro data, (c) filtering of sensor data, and (d) compensation of e-compass and gyro data based on calibration parameters. The power-save controller, which determines when to shut down different components of the target chip, may reside in either the sensor hub or the host.

The power-save controller may shut down different components in the target chip under different configurations or conditions. For example, the power-save controller may shut down both the RF portion and the Baseband portion of the GNSS receiver, or shut down only the RF portion of the GNSS receiver.

In some embodiments, when the GNSS receiver is in a power-save mode, it is desirable to improve the user experience by providing a position report to the user at a rate that is faster than the GNSS report rate. These intermediate position reports when the GNSS receiver is in sleep mode may be obtained by:
predicting the position based one of or all previous GNSS position, velocity, and acceleration measurements;
dead-reckoning using information from the sensors; or
blending the sensor-based position fixes with the GNSS-based predicted position fixes.

In the predicting and blending processes listed above, the predicted position fixes may become unreasonably inaccurate especially if the vehicle dynamics exhibit significant changes, such as sudden acceleration, sudden deceleration, and/or turns or heading changes. This disclosure describes various methods by which sensors and other external information may be employed to detect changes in vehicular dynamics thereby allowing corrective action to be taken to improve the quality of the position fix. Such action may include the following procedures:
(i) switching on the RF and Baseband portions of the GNSS receiver to exit the power-save/sleep mode and obtaining a fresh set of measurements from which new position fixes are obtained, or increasing the update rate at which new fixes are obtained;
(ii) obtaining position fixes solely from the dead-reckoning sensor solution; or
(iii) blending approaches i) and ii) to create a combination process.

Embodiments of the invention provide various methods for employing sensors that tell a GNSS receiver when to exit and enter the power-save mode.

### BRIEF DESCRIPTION OF THE DRAWINGS

Having thus described the invention in general terms, reference will now be made to the accompanying drawings, wherein:

FIG. 1 illustrates the timing of a navigation receiver that alternates between an active mode and a power-save or sleep mode;

FIG. 2 is a block diagram illustrating a power-save controller that resides in a sensor hub on a target chip;

FIG. 3 is a block diagram illustrating a power-save controller that resides in a sensor hub that is external to a target chip and a host;

FIG. 4 is a block diagram illustrating a power-save controller that resides in a target chip and that receives data from a sensor hub that is external to a target chip and a host;

FIG. 5 is a block diagram illustrating a sensor hub that resides in a host;

FIG. 6 is a block diagram illustrating a sensor hub that resides in a host;

FIG. 7 is a block diagram illustrating a sensor hub that resides external to target chip and host; and

FIG. 8 illustrates a flow chart of an exemplary process for controlling when a navigation receiver enters and exits a power-save mode.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

The exemplary embodiments described below refer to a GNSS navigation receiver, but it will be understood that the inventive concepts disclosed herein apply to any navigation receiver or other device that is used to determine a position fix. If the GNSS receiver is embodied in a mobile device, such as a smart phone, personal digital assistant (PDA), or other battery-operate device, then power consumption is likely to be an important consideration. If the GNSS receiver operates in the active mode at all times to provide a constantly updated location, then the mobile device's battery will be drained.

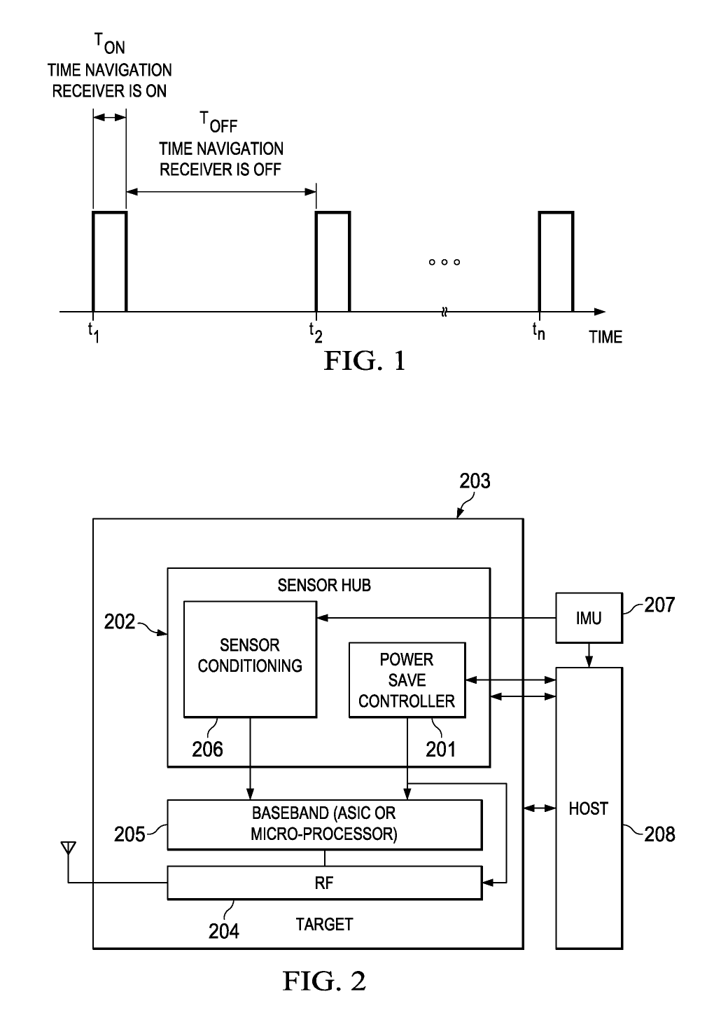

FIG. 1 illustrates the timing of a navigation receiver, such as a GNSS or RF receiver, that alternates between an active mode (i.e. “on”) and a power-save or sleep mode. The navigation receiver is in the active mode during time Tₒₙ and in the power-save mode during time T_{off}. The navigation receiver enters the active mode at times t₁, t₂, . . . tₙ, which may occur at regular or periodic intervals or at other times. In one embodiment, a sensor other than the navigation receiver determines non-periodic times t₁, t₂, . . . tₙ when the navigation receiver should enter the active mode. By alternating between the active mode and power-save mode, the GNSS may reduce or minimize its consumption of battery power. The duration of the power-save mode period T_{off} depends upon the operating conditions of the GNSS receiver. When the GNSS receiver is not moving, is moving at a relatively constant speed and heading (e.g., traveling on a straight-line highway), is moving in a predictable manner, and/or is operating in an open-sky environment (i.e., ready access to satellite or RF navigation signals), then the intervals between the active mode periods Tₒₙ may be extended. However, when the GNSS receiver is operating in a dynamic environment requiring frequent heading, course and/or speed changes or in a closed-sky environment (i.e., tunnels, urban-canyon/downtown, or other area of reduced or impaired access to satellite or RF navigation signals), then the intervals between the active mode periods Tₒₙ should be reduced.

Data from sensors other than the GNSS receiver may be used to identify when the GNSS receiver should operate in a power-save mode or in an active mode. For example, a mobile device may include position or motion sensors, such as accelerometers, gyroscopes, or an electronic compass (e-compass) in addition to the GNSS receiver. While the GNSS receiver is in a power-save mode, these position sensors can provide dead reckoning position updates for the navigation system. Also, these sensors detect when the mobile device has changed speed or heading and direct the GNSS receiver to enter the active mode to provide current position updates. Additional information, such as mapping data from the navigation system, may be used to determine when the GNSS receiver should enter the active mode. For example, if the mapping data shows the user is operating in an urban canyon/downtown area where tall buildings may create multipath signals or block satellite signals, then the GNSS receiver should operate in the active mode so that it can obtain position updates whenever a clear signal is available. If the mapping data shows that an upcoming expected, predicted or assigned route includes turns or possible course, heading and speed changes, then the GNSS receiver should operate in the active mode so that it can provide accurate position data during the turns or speed changes.

The GNSS receiver may be embodied in any number of configurations as disclosed in the examples shown in FIGS. 2-7. In some embodiments, the GNSS receiver may comprise both an RF subsystem and a Baseband (BB) subsystem. In the power-save mode, either or both of these subsystems may be turned off. In one embodiment, only the RF subsystem is turned off, and the BB subsystem stays in active mode to predict current position information during the power-save mode. In another embodiment, both the RF and BB subsystem are turned off and a host system predicts current position during the power-save mode.

In one embodiment, without limiting the overall invention, it is assumed herein that a GNSS receiver is known to be operating in a power-save mode. For other embodiments, it may be assumed that sensor-based calibration has been performed such that orientation of the sensor suite with respect to the drive/forward and lateral/transversal axis is known. The sensor solution will instruct the GNSS receiver to exit the power-save or sleep mode if any of the following conditions are met (A through D below):

(A) The Sensors Detect Sudden Acceleration/Deceleration.

The amount of acceleration or deceleration experienced can be quantified based on accelerometer readings or odometer/speedometer readings. A_{drive} is defined as the drive axis acceleration reading obtained from the sensors. The power-save mode is exited if the following condition is met for at least T seconds, continuously:

f_{Exit}(A_{drive})>Thresh_{acc} Eq. 1

where f_{Exit} (A_{drive}) is a function of drive acceleration readings. Some examples of the exit function, which are not intended to limit the invention, include:
(a) f_{Exit}(A_{drive})=|A_{drive}|, T=0;
(b) f_{Exit}(A_{drive})=|A_{drive}|, T=X, where X is a predefined number;
(c) f_{Exit}(A_{drive})=var(A_{drive}(k . . . k+X)), T=X, where X is a predefined number; and
(d) f_{Exit}(A_{drive})=std(A_{drive}(k . . . k+X)), T=X, where X is a predefined number.

In some embodiments the relative orientation of the sensor with respect to the user's drive/forward and lateral/transverse axes may not be known. In this case, A_{drive} is not known and the power-save mode is exited if one of the following conditions is met:

f_{Exit}(Aₓ,A_{y},A_{z})>Thresh_{acc1} Eq. 2

or

f_{Exit}(Aₓ,A_{y},A_{z})>Thresh_{acc2} Eq. 3

where f_{Exit} (Aₓ,A_{y},A_{z}) is a function of the three-axis accelerometer readings. Some non-limiting examples of the exit function include:

f_{Exit}(Aₓ,A_{y},A_{z})=\sqrt{Aₓ²+A_{y}²+A_{z}²} Eq. 4

and

f_{Exit}(Aₓ,A_{y},A_{z})=var(Ā(k), . . . , Ā(k+X)) Eq. 5

where

Ā(k)=\sqrt{Aₓ²(k)+A_{y}²(k)+A_{z}²(k)} Eq. 6

is the norm of the acceleration readings at time instant k and Xis the number of seconds over which the variance is computed.

Equation 5 and 6 above can be generalized to the condition

f_{Exit}(Aₓ,A_{y},A_{z})=f₁( A̅(k), . . . , A̅(k+X)) Eq. 7

where

A̅(k)=(|Aₓ(k)|^{p}+|A_{y}(k)|^{p}+|A_{z}(k)|^{p})^{1/p} Eq. 8

is the p^{th} norm on the acceleration signals at time k and f₁ is some operation on the resultant norms obtained for different time instants. For example, in Equation 5, f₁ was defined as the variance and the norm was the L2 or p=2.

(B) Sensors Detect a Change in Heading.

A change in the direction that a user moves—otherwise known as a change in heading—may be determined in several ways. By way of example, let

Δθ_{heading}(X)=θ_{heading}(t+X)−θ_{heading}(t) Eq. 9

denote the change in heading over a X seconds and let

$$\frac{\partial {θ}_{heading}}{\partial t} \qquad Eq . 10$$

denote the heading rate as may be computed by a gyroscope. Then, the power save mode is exited if any (or all) the following conditions are met (i through iv):

(i) If the condition |Δθ_{heading}(X)|>Thresh_{heading} is met, where Δθ_{heading}(X) is the change in heading, which may be obtained either using an e-compass or a gyroscope. For the e-compass case, this corresponds to taking the difference in heading measurements at two different time intervals. For the gyroscope this change is obtained by integrating the equivalent gyro output, for example:

$${Δθ}_{heading} ( X ) = {\int }_{t 1}^{t 1 + X} \frac{\partial {θ}_{heading}}{\partial t} d t \qquad Eq . 11$$

(ii) If the following condition is met:

$${f}_{Exit} ( \frac{\partial {θ}_{heading}}{\partial t} ) > {Thresh}_{headingrate} \qquad Eq . 12$$

where

$${f}_{Exit} ( \frac{\partial {θ}_{heading}}{\partial t} )$$

is a function of lateral acceleration readings. Some non-limiting examples of the exit function include:
(a) whenever the condition

$$\vert \frac{\partial {θ}_{heading}}{\partial t} \vert > {Thresh}_{headingrate}$$

is met;
(b) whenever the condition

$$\vert \frac{\partial {θ}_{heading}}{\partial t} \vert > {Thresh}_{headingrate}$$

is met for X seconds, wherein X is a predefined number; and
(c) whenever the variance or standard deviation of the lateral acceleration is above a threshold for X seconds, i.e.

$$var ( \frac{\partial {θ}_{heading} ( k … k + X )}{\partial t} ) > {Thresh}_{headingrate} .$$

The above embodiments (i) and (ii) assume that the heading rate

$$\frac{\partial {θ}_{heading}}{\partial t}$$

is available from the Yaw-axis gyro. This is only possible if the gyro's orientation is known with respect to the vehicle's drive axis. If this is not known, then the exit condition may be defined as a function of all three of the gyro outputs.

(iii) Let

$$( \frac{\partial {\dot{θ}}_{x}}{\partial t} , \frac{\partial {\dot{θ}}_{y}}{\partial t} , \frac{\partial {\dot{θ}}_{z}}{\partial t} )$$

denote the 3-tuple output from a three-axis gyro having an orientation that may or may not be known with respect to a vehicles drive axis. Then, the power-save mode is exited if the following condition is met:

$${f}_{Exit} ( \frac{\partial {\dot{θ}}_{x}}{\partial t} , \frac{\partial {\dot{θ}}_{y}}{\partial t} , \frac{\partial {\dot{θ}}_{z}}{\partial t} ) > {Thresh}_{gyro} \qquad Eq . 13$$

where

$${f}_{Exit} ( \frac{\partial {\dot{θ}}_{x}}{\partial t} , \frac{\partial {\dot{θ}}_{y}}{\partial t} , \frac{\partial {\dot{θ}}_{z}}{\partial t} )$$

is a function of the three-axis gyro readings. Some non-limiting examples of the exit function include:

$$\begin{matrix}( a ) {f}_{Exit} ( \frac{\partial {\dot{θ}}_{x}}{\partial t} , \frac{\partial {\dot{θ}}_{y}}{\partial t} , \frac{\partial {\dot{θ}}_{z}}{\partial t} ) = max ( \vert \frac{\partial {\dot{θ}}_{x}}{\partial t} \vert , \vert \frac{\partial {\dot{θ}}_{y}}{\partial t} \vert , \vert \frac{\partial {\dot{θ}}_{z}}{\partial t} \vert ) ; & Eq . 14 \\ ( b ) {f}_{Exit} ( \frac{\partial {\dot{θ}}_{x}}{\partial t} , \frac{\partial {\dot{θ}}_{y}}{\partial t} , \frac{\partial {\dot{θ}}_{z}}{\partial t} ) = \vert \frac{\partial {\dot{θ}}_{x}}{\partial t} \vert + \vert \frac{\partial {\dot{θ}}_{y}}{\partial t} \vert + \vert \frac{\partial {\dot{θ}}_{z}}{\partial t} \vert ; or & Eq . 15 \\ ( c ) {f}_{Exit} ( \frac{\partial {\dot{θ}}_{x}}{\partial t} , \frac{\partial {\dot{θ}}_{y}}{\partial t} , \frac{\partial {\dot{θ}}_{z}}{\partial t} ) = \vert \frac{\partial {\dot{θ}}_{x}}{\partial t} \vert \vert \frac{\partial {\dot{θ}}_{y}}{\partial t} \vert \vert \frac{\partial {\dot{θ}}_{z}}{\partial t} \vert . & Eq . 16\end{matrix}$$

(iv) In some embodiments an accelerometer may also be used to compute the heading rate. In these cases the heading rate may be computed as:

$$\frac{\partial {θ}_{heading}}{\partial t} = \frac{{A}_{lateral} ( t )}{{V}_{drive} ( t )} \qquad Eq . 17$$

where V_{drive} is the drive-axis speed. The drive-axis speed may be obtained from the last known GNSS reading or an odometer/speedometer reading, or the drive-axis speed may be a state that is being estimated in a Kalman-filter formulation. In some embodiments, a change in heading may be computed using only accelerometer measurements if either V_{drive} is above a threshold, or if Aₗₐₜₑᵣₐₗ is above a threshold, or if both V_{drive} and Aₗₐₜₑᵣₐₗ are above their threshold settings. In some embodiments, the heading rate computed by the accelerometer may be used in the algorithms described in Equations 10 and 11 and in sections (B)(i) and (B)(ii) above to compute the exit conditions.

In other embodiments involving an accelerometer, the speed information may be ignored and the power-save mode exited if the following condition is met:

f_{Exit}(Aₗₐₜₑᵣₐₗ)>Thresh_{acc} Eq. 18

where f_{Exit}(Aₗₐₜₑᵣₐₗ) is a function of lateral acceleration readings. Some non-limiting examples of the exit function include:
(a) whenever the condition |Aₗₐₜₑᵣₐₗ|>Thresh_{acc} is met;
(b) whenever the condition |Aₗₐₜₑᵣₐₗ|>Thresh_{acc} is met for X seconds, where X is a predefined number; or
c) whenever the variance or standard deviation of the lateral acceleration (A_{drive}) is above a threshold for X seconds, i.e. var(A_{drive}(k . . . k+X))>Thresh_{acc}.

(C) Map Based Detection in Change in Heading.

In some embodiments, the user-based position may be tracked based on map information. In such instances, the power-save mode may be exited if it is determined from the map that:
(a) there is a change in the road dynamics, such as, for example, turns in the road; or
(b) there is a possibility that the user may change the road on which or the direction in which he is travelling, such as, for example, at locations near exits on a highway or nearing a turn in a specific route.

(D) Sensor-Based Detection of Change in Position Estimate.

In some embodiments, while operating in the power-save mode, the sensor solution may be used to obtain a position estimate for intermediate points when the GNSS receiver is in sleep mode. In these cases, the GNSS receiver will periodically wake up every X seconds in order to obtain a new position fix. It is not required that Xbe constant in all embodiments. In other embodiments, Xmay be dynamically adapted. If the change in the GNSS-based position fix from the previous wake-up time instant is significantly different from that predicted by the dead-reckoning sensor solution, then the power-save mode may be exited. For example, the GNSS receiver will exit power save mode if:

|ΔPosGPS(n)−ΔPosSensor(n)|₂>thresh_{dist} Eq. 19

where in the above equation

ΔPosGPS(n)=|ΔPosGPS(n)−ΔPosGPS(n−1)|₂ Eq. 20

is the Euclidean distance change between the current GNSS position fix and the previous GNSS position fix; and

ΔPosSensor(n)=|ΔPosSensor(n)−ΔPosGPS(n−1)|₂ Eq. 21

is the Euclidean distance change between the sensor based position fix at time instant n and the previous GNSS position fix.

One of ordinary skill in the art will appreciate that there are several variants to the above embodiments. In some embodiments, the Euclidean distance metric may be computed for a two dimensional planar position solution, while in others it may be computed for all three dimensions. In yet other embodiments, instead of comparing the change in position fixes, a change in heading estimate may be compared instead. For example, the power-save mode may be exited if:

|ΔHeadingGPS(n)−ΔHeadingSensor(n)|₂>thresh_{heading1} Eq. 22

where in the above equation:

ΔHeadingGPS(n)=|ΔHeadingGPS(n)−ΔHeadingGPS(n−1)|₂ Eq. 23

is the change in heading between the current GNSS position fix and the previous GNSS position fix; and

ΔHeadingSensor(n)=|ΔHeadingSensor(n)−ΔHeadingGPS(n−1)|₂ Eq. 24

is the change in heading between the current sensor position fix and the previous GNSS position fix.

Approaches for When to Enter the Power-Save Mode

The power-save mode is entered by the GNSS when it is determined that the user is traveling in benign conditions. Some non-limiting methods used to identify whether a user is experiencing a benign condition include:
a) when the difference between two or more velocity fixes as measured by GNSS at specified time instances is less than a threshold which indicates negligible acceleration (this metric could be the variance or standard deviation of the velocities at each instant minus a reference velocity);
b) when the drive or lateral axis acceleration measurement as measured by the sensors is less than a threshold; and
c) when the change in heading—as measured by the sensors and/or GNSS—between two or more fixes measured at specified time instances is less than a threshold.
d) In some embodiments, the GNSS solution may determine whether it is in an urban-canyon environment or in an open-sky environment. An exemplary approach is disclosed pending U.S. patent application Ser. No. 12/573,890, filed Oct. 6, 2009, and titled “Enhancing Position Accuracy In Global Positioning System Receivers,” the disclosure of which is hereby incorporated by reference herein in its entirety. In such embodiments, the algorithm disclosed in the cited application may be used to indicate when the GNSS receiver is in open-sky, thus allowing for the GNSS receiver to enter a power-save mode. If the receiver is indicated to be in an urban-canyon environment other metrics may be tested, such as methods a-c listed above, before going into a power-save mode.
e) In some embodiments, based on map-based algorithms, it may be determined when a user is in an open-sky environment. In some embodiments the power save mode may be enabled only if the user is in an open-sky environment as determined by the map-based algorithm.

In other embodiments, a combination of the above-identified metrics may be used as an indicator of when to enter power-save. The above-listed metrics may also be used to determine the duty-cycle of the power-save mode, which indicates how long the GNSS receiver goes to sleep and how long it is awake. For example, certain applications that use GPS position outputs may have different accuracy requirements. For applications with less strict accuracy requirements, the conditions can be adapted so that it is easier to enter the power-save mode and more difficult to exit. For applications with demanding accuracy requirements, the conditions can be adapted so that it is more difficult to enter the power-save mode and easier to exit.

FIGS. 2-7 illustrate different configurations of exemplary mobile devices in which the navigation system components are partitioned in different ways for different embodiments.

FIG. 2 is a block diagram illustrating a power-save controller 201 that resides in a sensor hub 202 on a target chip 203. Power-save controller 201 is coupled to RF subsystem 204 and Baseband subsystem 205 and controls whether RF subsystem 204 and/or Baseband subsystem 205 operate in an active mode or a power-save/sleep mode. Sensor conditioning circuit 206 in sensor hub 202 receives data from Inertial Measurement Unit (IMU) 207, which may comprise, for example, accelerometers, gyroscopes, and/or an e-compass. Sensor conditioning circuit 206 cleans up and pre-processes data from IMU 207 and provides the IMU data to power-save controller 202 and Baseband subsystem 205. Host device 208 exchanges data with target chip 203, sensor hub 202, and power-save controller 201, such as position data and power-save status.

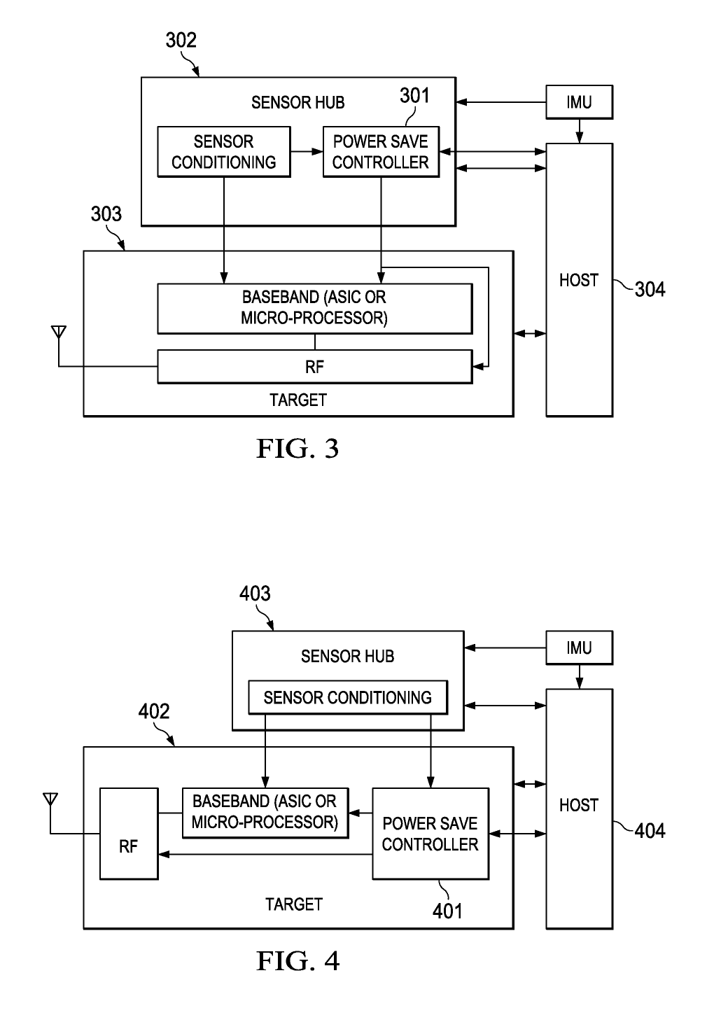

FIG. 3 is a block diagram illustrating a power-save controller 301 that resides in a sensor hub 302 that is external to target chip 303 and host 304.

FIG. 4 is a block diagram illustrating a power-save controller 401 that resides in a target chip 402 and that receives data from a sensor hub 403 that is external to target chip 402 and host 404.

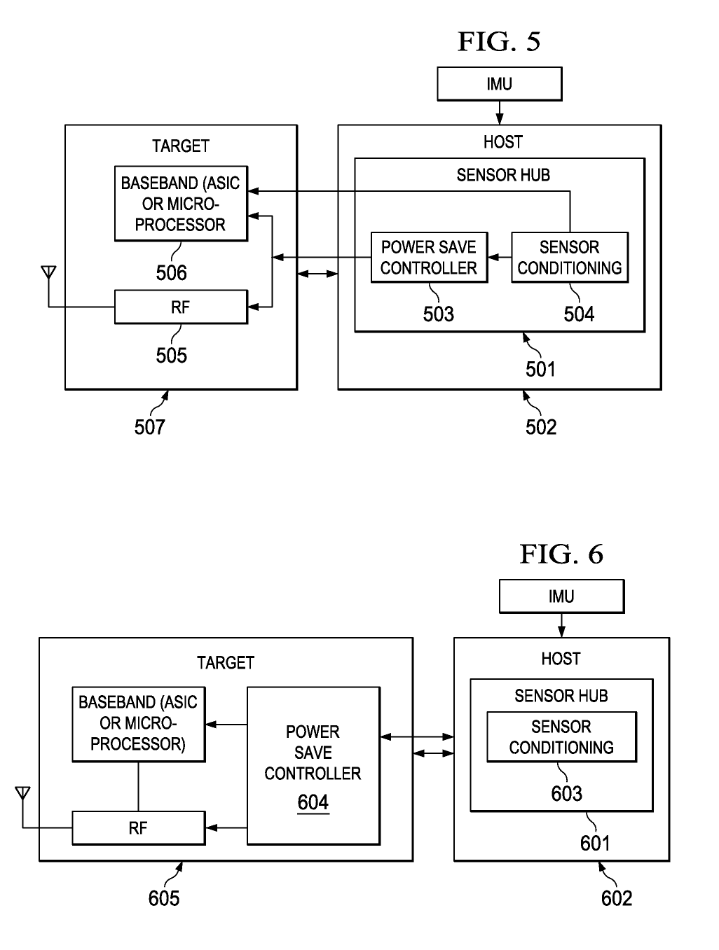

FIG. 5 is a block diagram illustrating a sensor hub 501 that resides in host 502. The sensor hub 501 has a power-save controller 503 and sensor conditioning circuit 504 and controls RF subsystem 505 and Baseband subsystem 506 in target chip 507.

FIG. 6 is a block diagram illustrating a sensor hub 601 that resides in host 602. The sensor hub 601 has a sensor conditioning circuit 603 and is coupled to power-save controller 604 in target chip 605.

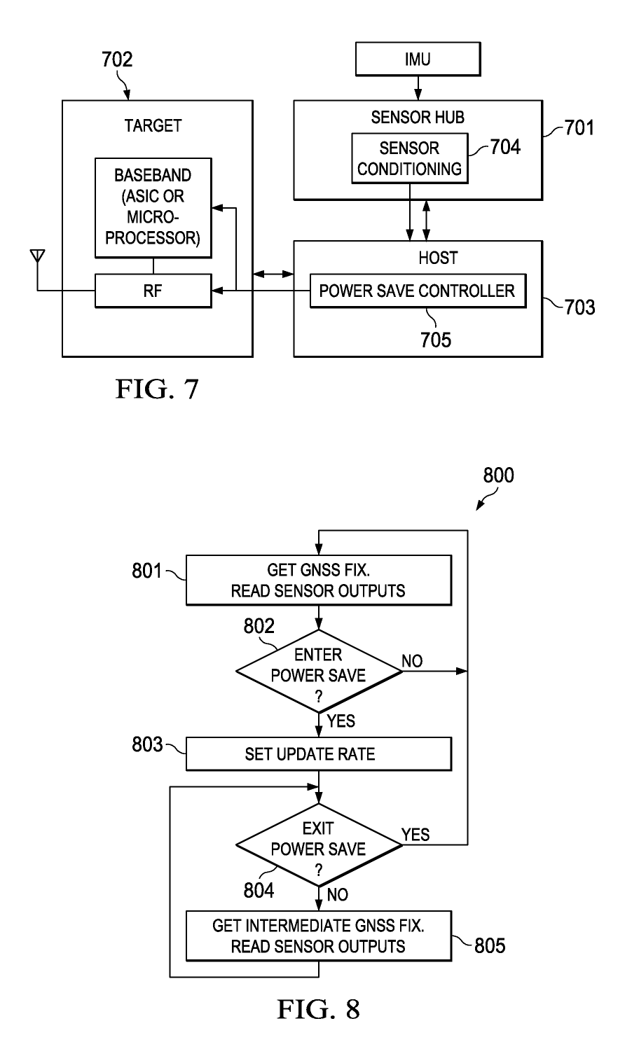

FIG. 7 is a block diagram illustrating a sensor hub 701 that resides external to target chip 702 and host 703. The sensor hub 701 has a sensor conditioning circuit 704 and is coupled to power-save controller 705 in host 703.

FIG. 8 illustrates a flow chart 800 of an exemplary process for controlling when a navigation receiver enters and exits a power-save mode. In step 801, the navigation system gets a current position fix from the navigation receiver. The system also reads current sensor outputs. In step 802, the system evaluates the sensor outputs and determines whether to enter the power-save mode. If the current conditions do not allow for entry into a power-save mode, such as when the navigation receiver is in a non-open-sky environment or is expected to change speed and heading, then the process returns to step 801 to get an updated position fix from the navigation receiver. If the current conditions allow for the power-save mode, such as when the user is operating in an open-sky environment with minimal expected changes in heading and speed, then the process puts the navigation receiver in power-save mode. The process moves to step 803 and sets an update rate for future position updates. The navigation system updates its position using dead reckoning while the navigation receiver is in power-save mode. In step 804, the navigation system determines whether to exit the power-save mode. At intervals determined by the update rate, the navigation receiver may enter the active state and return to step 801 to update the current position. Alternatively, in step 804 if the sensor data indicates a change in conditions, such as changes in heading or speed, the navigation receiver may enter active mode and the process returns to step 801. If, in step 804, the sensors have not indicated a change in conditions, then the process moves to step 805, and the navigation receiver temporarily enters the active mode to get an intermediate position fix. The navigation system also reads the sensor outputs in step 805 before returning to step 804.

Many modifications and other embodiments of the invention will come to mind to one skilled in the art to which this invention pertains having the benefit of the teachings presented in the foregoing descriptions, and the associated drawings. Therefore, it is to be understood that the invention is not to be limited to the specific embodiments disclosed. Although specific terms are employed herein, they are used in a generic and descriptive sense only and not for purposes of limitation.

What is claimed is:

1. A method for controlling a navigation device, comprising:
identifying a current position using a navigation receiver;
determining when the navigation receiver may enter a power-save mode;
placing the navigation receiver in a power-save mode;
while in the power-save mode, updating the current position using information from one or more position sensors;
controlling when the navigation receiver is enabled to determine an intermediate position; and
using the intermediate position to update the current position;
determining when the navigation receiver should exit the power-save mode; and
placing the navigation receiver in an active mode.

2. The method of claim 1, wherein the navigation receiver is a Global Navigation Satellite System (GNSS) receiver.

3. The method of claim 1, wherein the navigation receiver is a Global Positioning System (GPS) receiver.

4. The method of claim 1, wherein the navigation receiver is a WiFi receiver.

5. The method of claim 1, wherein updating the one or more position sensors comprise sensors selected from the group consisting of: an accelerometer, a gyroscope, and an electronic compass.

6. The method of claim 1, wherein the information from one or more position sensors includes current mapping information.

7. The method of claim 1, further comprising:
updating the current position using dead reckoning based upon the information from the one or more position sensors.

8. The method of claim 1, further comprising:
updating the current position using velocity estimates.

9. The method of claim 8, wherein the velocity estimates are determined from previous navigation receiver velocity estimates and sensor measurements.

10. The method of claim 1, wherein placing the navigation receiver in an active mode occurs at intervals corresponding to a preselected update rate.

11. The method of claim 1, further comprising:
adjusting an interval between active-mode operations based upon sensor measurements.

12. The method of claim 1, further comprising:
identifying a current operating condition that is incompatible with the power-save mode; and
placing the navigation receiver in an active mode.

13. The method of claim 12, wherein the current operating condition corresponds to a course requiring heading changes greater than a preselected threshold.

14. The method of claim 12, wherein the current operating condition corresponds to a course requiring speed changes greater than a preselected threshold.

15. The method of claim 12, wherein a function of the acceleration exceeds a threshold for a specified duration.

16. The method of claim 12, wherein the current operating condition corresponds to a course requiring travel in a non-open-sky location.

17. The method of claim 12, wherein the current operating condition corresponds to a course requiring travel in an urban-canyon location.

18. A system comprising:
a navigation receiver comprising a radio frequency (RF) subsystem and a baseband subsystem;
one or more position sensors; and
a power-save controller coupled to the navigation receiver and to the one or more position sensors, the power-save controller controlling a power-save mode for the navigation receiver based upon data from the one or more position sensors.

19. The system of claim 18, further comprising:
a sensor conditioning circuit coupled between the one or more position sensors and the power-save controller, the sensor conditioning circuit pre-processing data from the position sensors before passing the data to the power-save controller.

20. The system of claim 18, wherein the power-save controller turns off the RF subsystem during the power-save mode.

21. The system of claim 18, wherein the power-save controller turns off both the RF subsystem and the baseband subsystem during the power-save mode.

22. The system of claim 18, wherein the one or more position sensors are components of an inertial measurement unit.

23. The system of claim 18, wherein data from the one or more position sensors are used to update a location while the navigation receiver is in the power-save mode.

24. The system of claim 18, wherein the navigation receiver is a Global Navigation Satellite System (GNSS) receiver.

25. The system of claim 18, wherein the navigation receiver is a Global Positioning System (GPS) receiver.

26. The system of claim 18, wherein the navigation receiver is a WiFi receiver.

27. The system of claim 18, wherein the navigation receiver further comprises:
a Global Navigation Satellite System (GNSS) receiver and a WiFi receiver; and
wherein the power-save controller turns off the GNSS receiver, or turns off the WiFi receiver, or turns off both the GNSS and WiFi receivers during the power-save mode.

28. The system of claim 18, further comprising:
a sensor hub, wherein the power-save controller and the sensors conditioning circuit are components of the sensor hub.

29. The system of claim 18, wherein the one or more position sensors are selected from the group consisting of: an accelerometer, a gyroscope, and an electronic compass.

30. A method for controlling a navigation receiver, comprising:
determining a current position;
receiving data from position sensors;
placing the navigation receiver in a power-save mode;
determining an update rate for the navigation receiver;
updating the current position using the data from the position sensors;
placing the navigation receiver temporarily in an active mode at update intervals to determine an intermediate position; and
updating the current position using intermediate position data.
